(19) United States
(12) Patent Application Publication
(10) Pub. No.: US 2017/0010762 A1
(43) Pub. Date: Jan. 12, 2017

(54) CONTROLLING APPLICATION WINDOWS WITH A HOVER POP-UP PANEL

(71) Applicant: Honeywell International Inc., Morristown, NJ (US)

(72) Inventors: JAMES ADAMS, GLENDALE, AZ (US); SOSATI LIM, NORTH PARRAMATTA (AU); GRAEME LAYCOCK, HUNTERS HILL, NSW (AU)

(21) Appl. No.: 14/796,706

(22) Filed: Jul. 10, 2015

(51) Int. Cl. G06F 3/0482; G06F 3/0354; G06F 3/0481; G06F 3/0484

(52) U.S. Cl. CPC G06F 3/0482; G06F 3/04847; G06F 3/03543; G06F 3/04812; G06F 2203/04803

(57) ABSTRACT

A method of window control for display screens includes providing at least one display screen including at least a first application display window (first window), where the first window is exclusive of any dedicated area for selecting window-control functions (WCFs). A detect signal is generated responsive to detecting a mouse pointer hovering over a pre-defined trigger area of the first window. A detect signal is sent to a processor which is coupled to a display driver that is coupled to drive the display screen. Responsive to receiving the detect signal, the processor and display driver cause the displaying of a window control panel (WCP) as a popup within the first window, where the WCP includes a plurality of WCFs including at least close and maximize.

### FIELD

Disclosed embodiments relate to window control of computer display screens.

### BACKGROUND

Modern computer display technology affords increased resolution and larger screen sizes which enable an ever increasing density of application displays. Displays generally have dedicated areas for window-control functions, typically located in the title bar region, to provide control functions such as window maximize and window-close. Myriad displays which comprise two or more displays under common user' control is one type of display commonly used in the control room of manufacturing plants.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize conventional application displays which have dedicated areas for window-control functions (WCFs) typically in the title bar region of the display can create an overly busy look and feel, particularly for myriad displays, and also consume screen area on generally seldom utilized control functions. Removing this dedicated area for selecting WCFs addresses this busyness problem, but creates a significant new problem of how to initiate WCFs on windows whose WCFs have been removed.

Disclosed embodiments solve the problem of window control for application displays without any dedicated areas for selecting WCFs. For example, in contrast to each display in a myriad display (and each window in the display for multi-window displays) conventionally having their own dedicated area with icons for governing WCFs, such as maximize-window, close window, a window control panel (WCP) with a hover menu including a plurality of icons for WCFs therein is provided on each of the display screen window (window) as a pop-up to the user only after the user “hovers” their mouse-pointer (mouse) over a designated trigger area in the window.

The trigger area can comprise a portion of the WCP. Disclosed WCPs provide the ability to perform a range of WCFs including, but not limited to: close, maximize, fast-update, output-focus and global output-focus. Close and maximize are generally standard computer WCFs, minimize is optional, while fast-update, output-focus and global-output-focus are examples of more specific WCFs that may be used in certain “managed display” environments commonly provided in manufacturing production control rooms.

A “mouse” as known in the art is a commonly used computer input device, where generally the mouse movement is visually fed back to the user by a graphic symbol or cursor displayed on the display screen that copies the mouse's movement creating the illusion in the mind of user of directly moving it with his or her own hand. Application programs derive user commands according to spatial relationships between the displayed information and the cursor's position on the screen. Disclosed embodiments may be practiced with either a wired mouse or with a wireless mouse.

### BRIEF DESCRIPTION OF THE DRAWINGS

FIG. 1 is a block diagram of an industrial plant control system having a display screen with a hover pop-up panel-based application display controller that implements a disclosed method of hover pop-up panel-based application window control for display screens, according to an example embodiment.

FIG. 2 is a flow chart that shows steps in an example method of hover pop-up panel-based application window control for display screens, according to an example embodiment.

FIG. 3 is a more detailed block diagram of components of the computer system shown in FIG. 1.

FIG. 4A is an example screenshot showing an example hover menu including a plurality of WCF icons in a WCP, FIG. 4B is an example screenshot including a WCP showing window control states, FIG. 4C is an example screenshot showing a window displaying only the currently ON icons, but not showing the WCP or the OFF or unavailable WCFs, and FIG. 4D is an example WCP in a maximized state with an arrow pointing to a restore icon, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Disclosed hover pop-up panel-based application display controller embodiments implement a method of hover pop-up panel-based application window control for providing WCFs for display screens which generally requires no change to the computer hardware, where disclosed program code determines when the mouse of an operator or other user is hovering over a generally small designated trigger area (e.g., near the upper right portion or upper left portion of the window), and when in the trigger area a temporary WCP is automatically presented on that window. As the trigger area is generally not shown in the windows, the trigger area can be discovered by a user by discovery (trial and error) or by training.

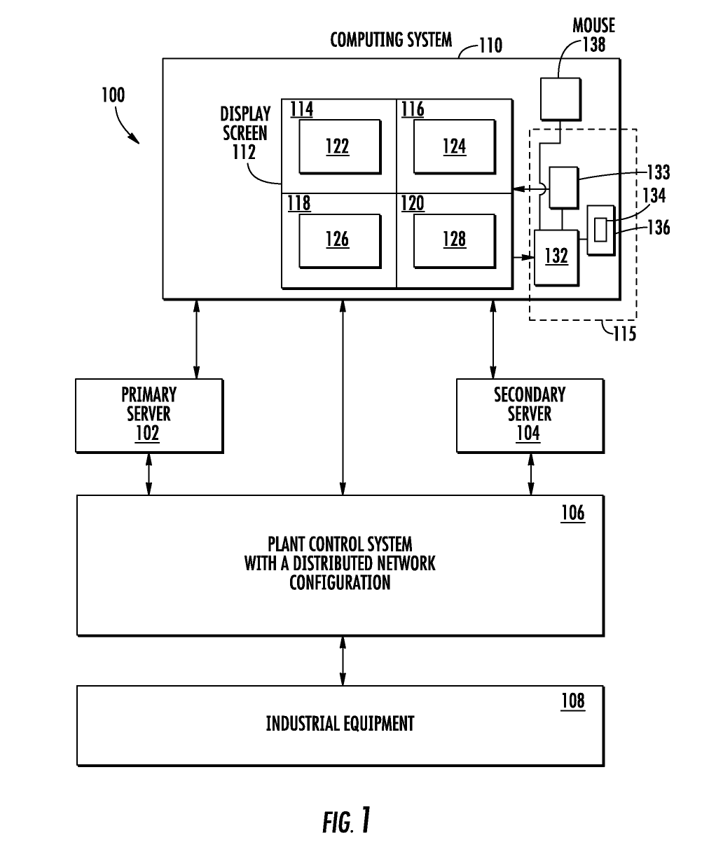

FIG. 1 is a block diagram of an industrial plant control system (IPCS) 100 comprising a computing system 110 including a hover pop-up panel-based application display controller 115 controlling a display screen 112 shown having multiple display windows (windows), according to an example embodiment. Although the display screen 112 in FIG. 1 is shown having multiple windows, disclosed embodiments also apply to displays having a single window as well.

The display screen 112 and display controller 115 collectively function to display a set of display windows 114, 116, 118, 120 to the operator or other user (not shown) that uses a mouse 138 as a user interface device, generally along with a keyboard. There are monitor-control graphical user interfaces (MCGUIs) 122, 124, 126, 128 shown in the display windows 114, 116, 118, 120, respectively. The computing system 110 may be a desktop personal computer system, a laptop personal computer system, a personal digital assistant, a mobile computing device, or any other general purpose computer processing device. As used herein, a “display screen” can comprise display types other than MCGUI-type displays, such as a typical computer display, for example a notepad.

The phrase “monitor-control graphical user interface” as used herein refers to a GUI which displays information and generally provides command control for monitoring and/or controlling applications, such as for an industrial process or industrial equipment. The MCGUIs 122, 124, 126, 128 typically include a text display area (not shown), a video display area (not shown), an image display area (not shown), command buttons (not shown), scroll bars (not shown), and/or the like. Each of the MCGUIs 122, 124, 126, 128 is displayed in a particular display window 114, 116, 118, 120. For example, an MCGUI 122 is displayed in the display window 114. Similarly, the MCGUI 124 is displayed in the display window 116. Likewise, the MCGUI 126 is displayed in the display window 118. The MCGUI 128 is displayed in the display window 120. However, it should be understood that more than one GUI can be displayed in each of the display windows 114, 116, 118, 120.

The term “window” as used herein refers to a visual area of a display screen containing content. Such content can include, but is not limited to, still images, video images, an animated image, text, graphs, charts, data, GUIs, or any other information useful in monitoring an area of interest and/or controlling a desired process. In the industrial process scenario, the GUIs can contain information necessary for enabling an operator (not shown) to monitor and/or control an industrial process or equipment. Such information includes, but is not limited to, real-time images of industrial equipment (e.g., a tank filled with a liquid), data indicating temperature of a particular area of an industrial plant, data indicating temperature of a liquid used in an industrial process, and data indicating how much liquid is in a particular container.

There are many types of IPCS known in the art for controlling industrial equipment and processes. IPCS 100 includes a primary server 102, an operator computing system 110, an optional secondary (or back-up) server 104, a plant control system 106, and industrial processing equipment 108. The plant control system 106 has a distributed network configuration, i.e., there are application specific modules communicably connected to each other, industrial equipment, and operator interfaces via a local control network.

Each of the components 102, 110, 104, 106, and 108 is known to those having ordinary skill in the art, and therefore will not be described in detail herein. The computing system 110 is configured to enable the control of the industrial equipment 108 by an operator (not shown, such as in a control room) interacting using the mouse 138.

Display controller 115 includes software code (code) 134 stored in a memory (e.g., read only memory, (ROM), or random access memory (RAM)) 136 executable by a processing device 132 for implementing a disclosed method of hover pop-up panel-based application window control for display screens. Processing device 132 is coupled to a display driver 133 which drives the display screen 112. The processing device 132 can comprise a microprocessor, digital signal processor (DSP) or microcontroller unit (MCU). The user interface generally comprises a keyboard (not shown), and the mouse 138. The display screen 112 can also be touch sensitive.

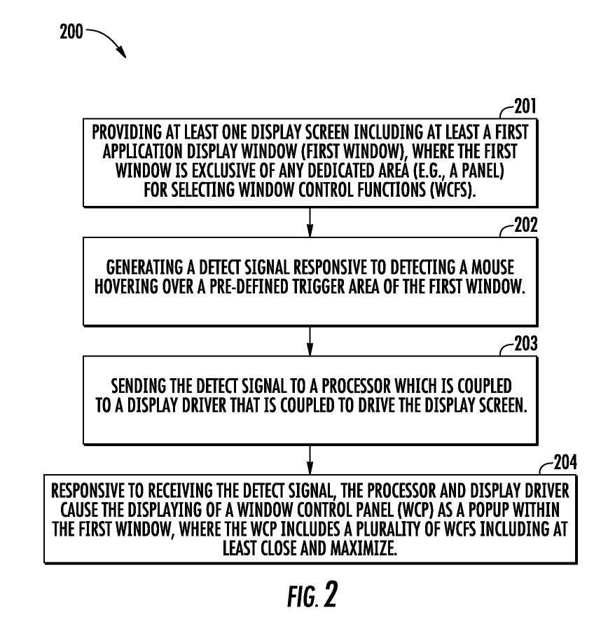

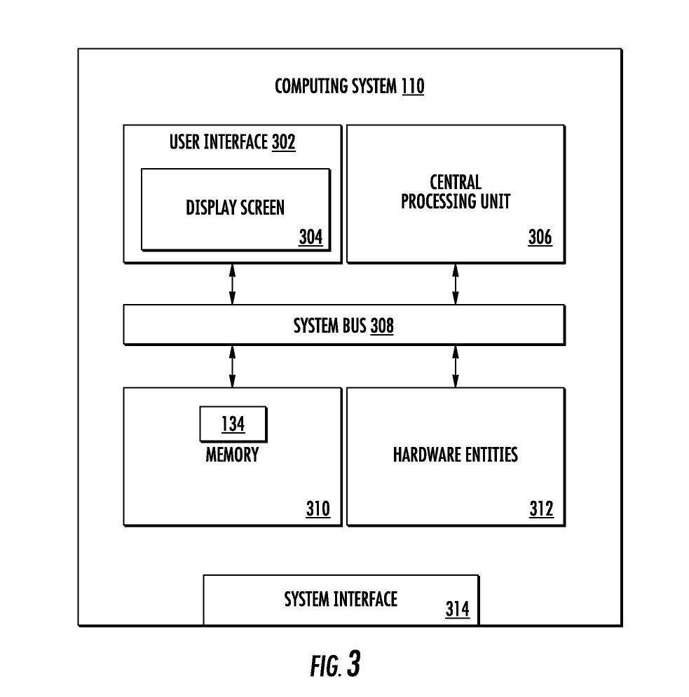

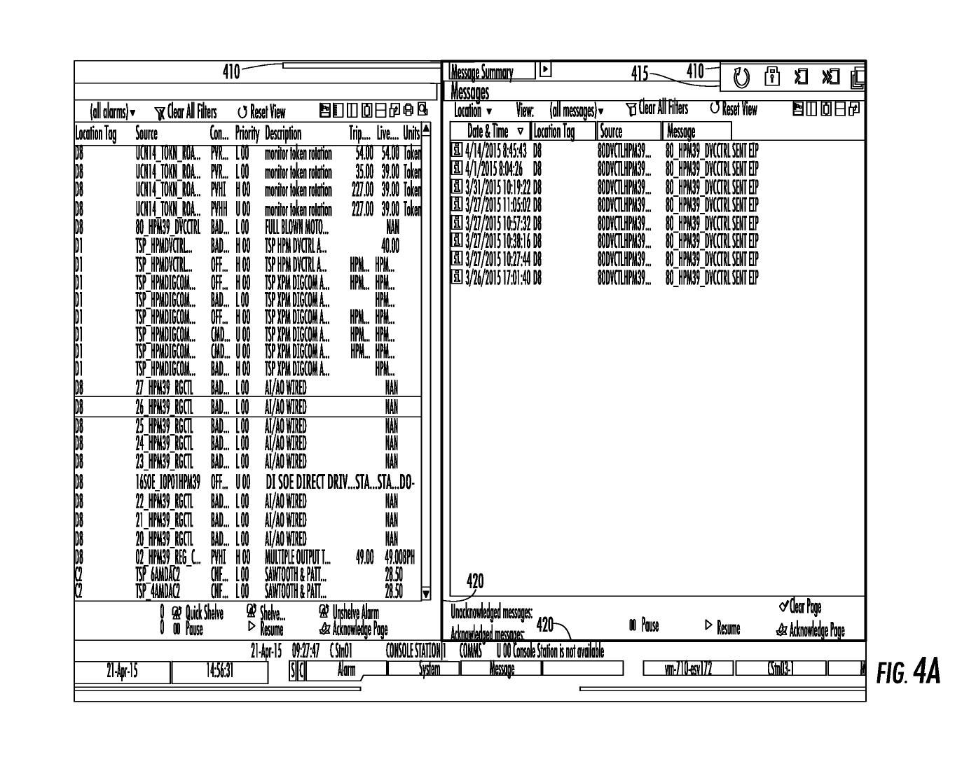

FIG. 2 is a flow chart that shows steps in an example method 200 of window control for display screens, according to an example embodiment. Step 201 comprises providing at least one display screen including at least a first window, where the first window is exclusive of any dedicated (i.e., continuously shown) area (e.g., a panel) showing icons for WCFs for selecting WCFs.

Step 202 comprises generating a detect signal responsive to detecting a mouse hovering over a pre-defined trigger area of the first window. As noted above, the trigger area can be within the area the WCP is displayed. As known in the art, mouse position detection to enable step 202 is standard on computers. Step 203 comprises sending the detect signal to a processor which is coupled to a display driver that is coupled to drive the display screen. In step 204, responsive to receiving the detect signal, the processor and display driver cause the displaying of a WCP as a popup within the first window, where the WCP includes icons each associated with a WCF including at least close and maximize.

The WCFs can further comprise minimize, as well as fast-update, output-focus and global output-focus which are examples of more specific WCFs that may be applicable in certain “managed display” environments as may be seen in manufacturing production control rooms. The fast-update provides a “mode” in which a given (aka MCGUI) monitoring and control GUI could be placed into a mode of consuming process-control data resources at a higher rate, by “updating fast”. Fast-update is applicable for process data (e.g., from a plant), but not for text, so that fast-update will generable not be available for selection (so that its icon is shown unavailable in the WCP, such as being shown as greyed to indicate being unavailable) when text is displayed in the window.

Output-focus provides a mechanism whereby in a given set of similar application displays, which of that set of displays would be replaced (closed, shut down) upon invocation of new display that belongs to set of displays, or types of displays, that would belong to that group of similar application displays. Global-output-focus provides a mechanism whereby, regardless of the type of display that may next be invoked, the one and only global-output-focus MCGUI would be replaced upon invocation of a new MCGUI application display. Another WCF is the “window-lock option” defined as a way to preclude the automatic incrementing of an output-focus status to be applied to a given window that exists within a set of two or more similar application displays.

When the mouse 138 of an operator (or other user) is hovering over the trigger area the WCP with a hover menu therein pops-up in response can show not only icons for the WCFs provided, but can also show the current state of those WCFs which have state information, which can define three (3) different current states, 1) disabled/unavailable (unavailable), such as the icon shown grayed out, and for available WCFs 2) enabled but not currently engaged (OFF), for example the icon shown ungrayed/unhighlighted, or 3) ON/engaged (ON), such as the icon shown either highlighted (as in output-focus, global output-focus), modified (as in maximized and locked vs. unlocked) or animated (as in fast update). A user can toggle between ON and OFF for an available WCF, except for WCFs that when turned OFF by themselves results in insufficient system guidance. For example, output-focus when ON to “make the next display information go here”, is an example exception to two-way toggling because turning it OFF by itself is insufficient system guidance as a user typically also selects a different window to have the output-focus set ON, i.e. selects an output-focus for another window.

One or more WCFs may be unavailable, such as fast-update while text is being displayed in the window as described above. Unavailable is generally uniquely represented to distinguish it from OFF, such as by the icon being grayed out. State information being ON or OFF is generally provided for fast-update, window-lock, output-focus, global-output focus, maximize/restore, and window close. Each WCF available for selection may be selected by clicking on its associated icon to render it ON in order to execute the desired WCF option (e.g., fast-update or maximize/restore).

Other example WCFs that can be included, including acknowledge-alarm, confirm-message, and window-drag. Alarm state can be indicated showing a status icon, e.g., “no alarms present”, “alarms present, highest current alarm is low, high or emergency” and also elaborated to indicate graphically a mix of the alarms (e.g., a pie chart) with its selection causing an action of either invoking the alarm summary page or (as may be configured) acknowledging the unacknowledged alarms. Message state can be similarly indicated, showing an indication of current messages, those that have yet to be confirmed, and those yet to be acknowledged. Window drag may be a target area presented on the WCP which when clicked and dragged, allows a user to reposition the window to the desired location. The user may then select and thereby execute a desired available WCF, or simply move the mouse 138 away out from the area of the WCP, both of which actions can result in the WCP being removed from sight. Disclosed code 134 can monitor movements of the mouse 138 while the WCP remains presented. The result is the ability to control windows without conventionally requiring a dedicated screen area (e.g., title bar area) for selecting WCFs nor the attendant conventional screen clutter from a conventional dedicated control panel.

The WCP stops being displayed promptly after it is no longer being hovered over the WCP. There can be a timer, which can be user configurable, to determine how long after the mouse exits the WCP to continue to present the WCP in the window. The WCP can also be “opted out” temporarily by either a generic mechanism (e.g. adding a “window property”) or in real time, e.g. by a user holding down the “control” key, for example if a user decides he or she does not want to have the WCP shown to allow viewing needed information in the area of the WCP.

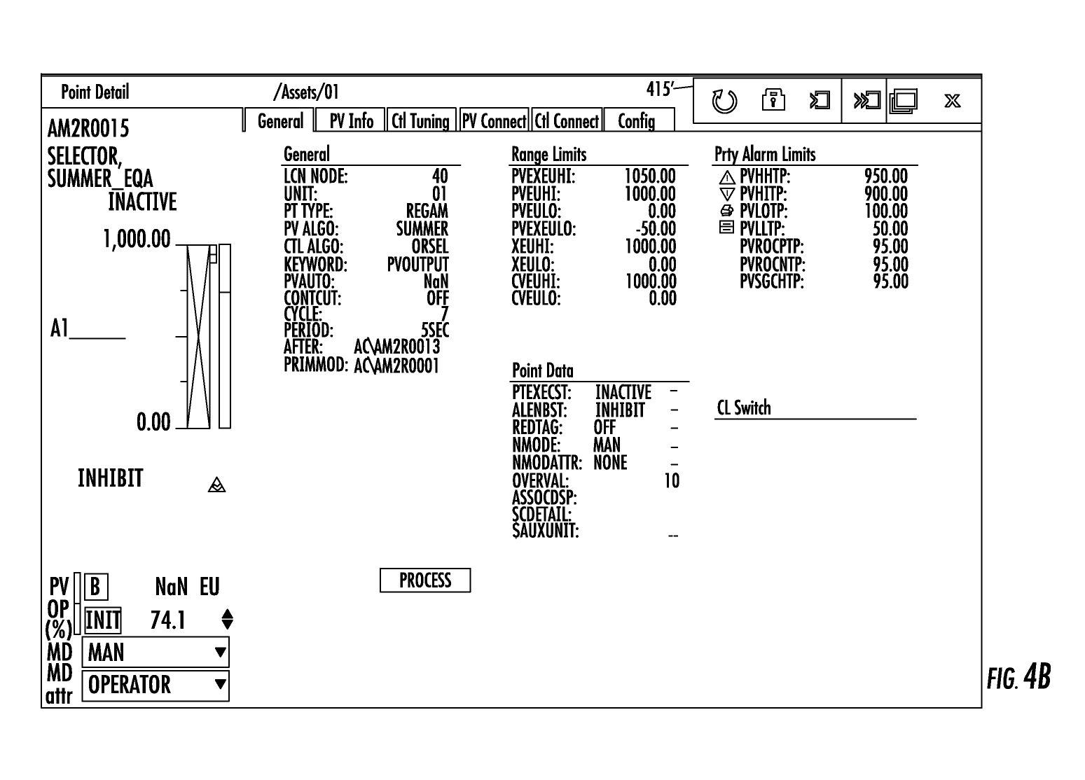

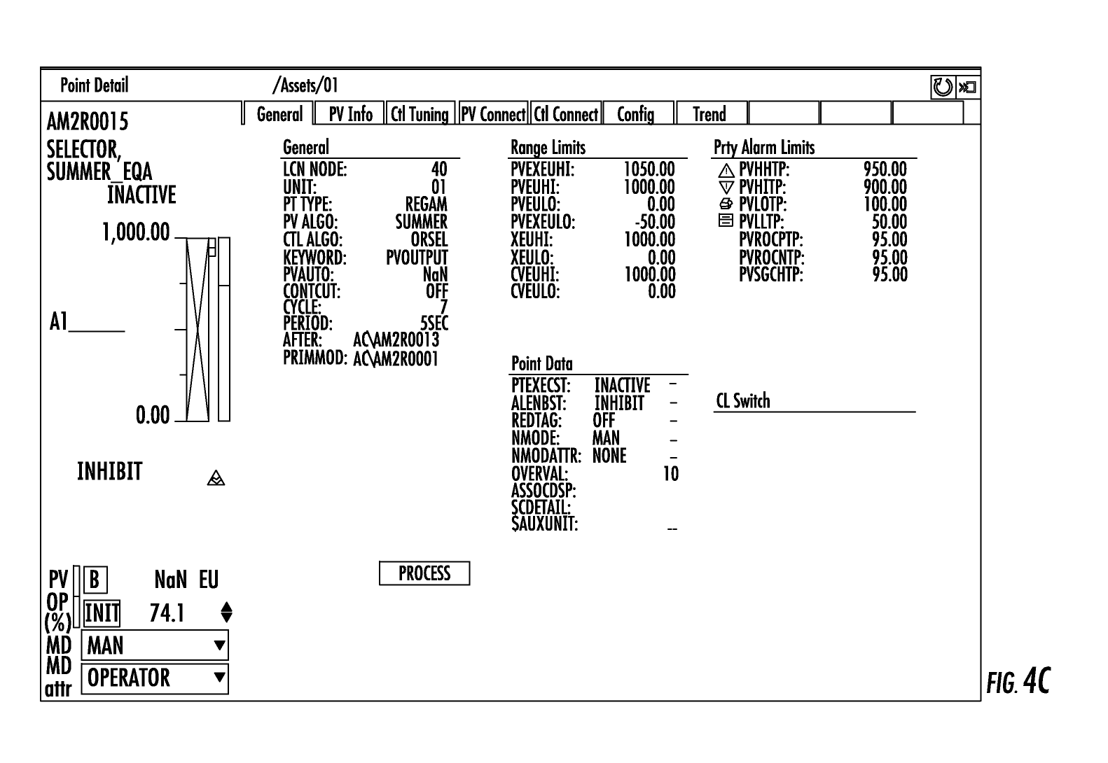

Referring now to FIG. 3, there is provided a more detailed block diagram of the components of the computer system 110 shown in FIG. 1 with the display screen now shown as 304. As shown in FIG. 3, the computer system 110 comprises a system interface 314, a user interface 302, a central processing unit (CPU) 306, a system bus 308, a memory 310 connected to and accessible by other portions of the computer system 110 through the system bus 308, and hardware entities 312 connected to the system bus 308. At least some of the hardware entities 312 perform actions involving access to and use of the memory 310, which for example may be a RAM, a disk driver, and/or a compact disc read only memory (CD-ROM). The hardware entities 312 may include processors such as microprocessors, application specific integrated circuits (ASICs), or other hardware. The hardware entities 312 may include a microprocessor programmed for communicating with a primary and secondary server.

### EXAMPLES

Disclosed embodiments are further illustrated by the following specific Examples, which should not be construed as limiting the scope or content of this Disclosure in any way.

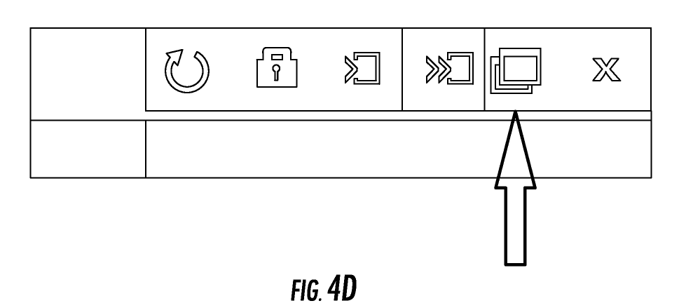

FIG. 4A is an example screenshot of a display having two side-by-side windows showing an example hover menu in the WCP 415 of the rightmost window, according to an example embodiment. The trigger area 410 defined by the outlined rectangular region shown in both windows in FIG. 4A is not actually shown to the user, and is only depicted in FIG. 4A to define the area this region. When the mouse of an operator (or other user) hovers in the rightmost window over the trigger area 410 the WCP 415 with its hover menu showing a plurality of WCF icons appears as shown. The display windows are showing process-related information, with the leftmost window shown displaying an alarm summary, and the rightmost window shown displaying a message summary (with date and time information).

There five WCF icons shown in the WCP 415, with fast-update, display-lock, output-focus global, output-focus, and maximize shown left to right. A close icon (generally an “X”) that is generally to the right of the maximize icon is not shown in FIG. 4A. A high illumination level is used for the fast-update, output-focus, global-output focus and maximize indicating a current ON state, and the display lock having a grayed appearance is for indicating a current unavailable state. The size of the trigger area 410 (e.g., default height of 7 pixels), and the width of the WCP 415 can be configured to be larger or smaller.

The rightmost display window is shown having a distinctive border pattern 420 shown with a thicker black line border indicating it is the display window of the plurality of display windows that is currently “active” (where the keyboard or mouse input would be directed). The distinctive border pattern may also be differently colored, such as a blue border vs. a non-active thin line black border. The mechanism chosen is to draw, each time a given window becomes active, a recognizably distinct border around that window. One particular example color and thickness that can be default values are cyan/blue and 2-pixels wide, respectively. Similarly, each inactive display window is provided a typically less distinctive border.

FIG. 4B is an example screenshot shown including a WCP 415′ showing window control states, according to an example embodiment. The window states are shown including two OFF WCFs being the display-lock and output-focus. Fast update, global-output focus, maximize and close are shown currently ON. The data shown in the window comprises a process control point detail display.

The example screenshot of FIG. 4C shows a window displaying only the currently ON icons shown for fast update and global-output focus, but not showing the WCP or the OFF or unavailable WCFs. Previously a user's mouse entered the trigger area and a WCP such as WCP 415 shown in FIG. 4A popped up, and the user selected the fast update and global-output focus to render them ON. Upon the user's mouse moving out of the WCP, the WCP disappeared. Upon updated information being received and displayed in this window, this option depicted in FIG. 4C displays only the ON WCFs in this case being fast update and global-output focus in the area of the WCP, without the WCP or the OFF or unavailable WCFs being shown. The ON WCFs shown may be dynamically (i.e., temporarily) made invisible by user action, such as pressing a “control” key. It is noted that global output-focus and output-focus states cannot be ON if the display lock is ON and vice versa. Accordingly, since a window that is not showing the WCP shows only the ON WCF icons, it will generally never show all of the available WCF icons at any given time (since some are mutually exclusive).

Regarding “fast update” and “global-output focus”, only one window system-wide can generally be “fast update”, and for “global-output focus”. “Fast update” means this window is temporarily putting heavier burden on the data access network by retrieving data at a higher rate. “Global-output focus” means regardless of normal workspace window-replacement configuration logic, put the next invoked display here.

Regarding “display lock” and “output-focus”, these WCFs cannot generally both be active, but both can be available for enabling at same time. These two types of groupings allow for a set of “like” displays to positioned similarly into a defined collection of locations (e.g. replace a specific set of displays in an orderly, predictable manner, such as “round robin replacement”). Round robin, as the name indicates, means the “next window to be replaced”—aka the “output-focus” window is incremented automatically, as each new display of that ilk is invoked. Manual select is identical but for the ‘auto-increment of output-focus mechanism, hence one manually selects the ‘output-focus’ window, if one wishes to change it among a group of such windows. The display lock icon provides a free pass by which the round robin auto-increment mechanism “skips” a given window in a round robin group. Accordingly, the display lock icon's status will be shown as disabled (or not available) if a) the window is not part of a round robin group, or b) the round robin group has a total of just one window (possible), or c) no other windows in the round robin group are available (e.g. three of the four windows in a round robin group are already locked.).

FIG. 4D is an example WCP in a maximized (enlarged) state with an arrow added pointing to a maximize icon shown with a double box indicating the option for returning the display to its original dimensions which would then have the maximize icon shown with a single box.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

1. A method of window control for display screens, comprising:
providing at least one display screen that includes at least a first application display window (first window), said first window being exclusive of any dedicated area for selecting window-control functions (WCFs);
generating a detect signal responsive to detecting a mouse hovering over a pre-defined trigger area of said first window;
sending said detect signal to a processor which is coupled to a display driver that is coupled to drive said display screen, and
responsive to receiving said detect signal, said processor and said display driver causing a displaying of a window control panel (WCP) as a popup within said first window, said WCP including a plurality of said WCFs including at least close and maximize.

2. The method of claim 1, wherein at least a first of said plurality of said WCFs (first WCF) provides a visible indication of its current state information, said visible indication including a first indication indicating a current ON state and at least a second indication indicating a current OFF state, further comprising toggling between said ON state and said OFF state.

3. The method of claim 2, wherein said visible indication further comprises a third indication indicating a current unavailable state.

4. The method of claim 1, wherein said display screen is within a production control room of a manufacturing plant.

5. The method of claim 4, wherein said WCFs further comprise fast-update, output-focus and global output focus.

6. The method of claim 1, wherein said display screen has a plurality of said display windows each having said trigger area.

7. The method of claim 6, further comprising displaying a distinctive border pattern around an active one of said plurality of said display windows (active display window) for indicating said mouse is within said trigger area of said active display window.

8. The method of claim 1, wherein said at least one display screen includes a plurality of said display screens all being coupled to be controlled together.

9. The method of claim 1, wherein said WCP continues to be displayed only while said mouse is within an area of said WCP and for a predetermined period of time after said mouse exits said area of said WCP.

10. The method of claim 9, further comprising a user setting said predetermined period of time.

11. A software product, comprising:
a non-transitory data storage medium that includes program instructions (code) executable by a processor which is coupled to a display driver coupled to drive at least one display screen having at least a first application display window (first window) to enable executing a method of window control for said display screen, said method comprising:
configuring said first window to be exclusive of any dedicated area for selecting window-control functions (WCFs);
generating a detect signal responsive to detecting a mouse hovering over a pre-defined trigger area of said first window;
sending said detect signal to said processor, and
responsive to said processor receiving said detect signal, causing a displaying of a window control panel (WCP) as a popup within said first window, said WCP including a plurality of said WCFs including at least close and maximize.

12. The software product of claim 11, wherein at least a first of said plurality of said WCFs (first WCF) provides a visible indication of its current state information, said visible indication including a first indication indicating a current ON state and at least a second indication indicating a current OFF state, and said code further comprising code for toggling between said ON state and said OFF state.

13. The software product of claim 12, wherein said visible indication further comprises a third indication indicating a current unavailable state.

14. The software product of claim 11, wherein said WCFs further comprise fast-update, output-focus and global-output-focus.

15. The software product of claim 11, wherein said display screen has a plurality of said display windows each having said trigger area.

16. The software product of claim 15, further comprising code for displaying a distinctive border pattern around an active one of said plurality of said display windows (active display window) for indicating said mouse is within said trigger area of said active display window.

17. The software product of claim 11, wherein said at least one display screen includes a plurality of said display screens all being coupled to be controllable together.

18. The software product of claim 11, wherein said WCP continues to be displayed only while said mouse is within an area of said WCP and for a predetermined period of time after said mouse exits said area of said WCP.

19. The software product of claim 18, further comprising code for enabling a user to set said predetermined period of time.
